(19) United States
(12) Patent Application Publication
(10) Pub. No.: US 2026/0163795 A1
(43) Pub. Date: Jun. 11, 2026

(54) DYNAMIC ON DEMAND INTER-OPERATOR CARRIER AGGREGATION

(71) Applicant: AT&T Intellectual Property I, L.P., Atlanta, GA (US)

(72) Inventors: Joseph Soryal, Glendale, NY (US); Neel Patel, Short Hills, NJ (US); Venson Shaw, Kirkland, WA (US)

(21) Appl. No.: 18/977,889

(22) Filed: Dec. 11, 2024

(51) Int. Cl. H04L 41/0806; H04L 41/147

(52) U.S. Cl. CPC H04L 41/0806; H04L 41/147

(57) ABSTRACT

A processing system including at least one processor may perform a forecast of data traffic of a cellular network and detect a need for an inter-operator carrier aggregation service in a future time period based on the forecast. The processing system may then select a first carrier component from at least one non-cellular network, wherein the at least one non-cellular network is distinct from the cellular network and instantiate the inter-operator carrier aggregation service in the cellular network for an endpoint device, wherein the inter-operator carrier aggregation service implements a carrier aggregation process utilizing the first carrier component from the at least one non-cellular network and a second carrier component from the cellar network to provide data transmission to the endpoint device.

The present disclosure relates generally to communication networks, and more particularly to methods, non-transitory computer-readable media, and apparatuses for implementing carrier aggregations of carriers from a plurality of disparate communication operator networks, e.g., providing a dynamic on demand inter-operator carrier aggregation service.

### BACKGROUND

Carrier aggregation (CA) is a technique used in wireless communications to increase a user endpoint device's data rate by assigning multiple component carriers (i.e., frequency blocks) to the same user endpoint device, effectively creating a wider channel for data transmissions. The greater the number of component carriers assigned to the user endpoint device, the wider the channel, and, consequently, the greater the increase in the maximum possible data rate the user endpoint device experiences. Carrier aggregation can not only boost the throughput the user endpoint device experiences, but can also reduce the latency. However, carrier aggregation is often utilized by a single operator of a single communication network (e.g., a single mobile carrier or operator) to provide multiple component carriers that are within the direct control of the single operator to support its subscribers.

### SUMMARY

In one example, the present disclosure discloses a method, computer-readable medium, and apparatus for providing a dynamic on demand inter-operator carrier aggregation service. For example, a processing system including at least one processor may perform a forecast of data traffic of a cellular network, detect a need for an inter-operator carrier aggregation service in a future time period based on the forecast, select a first carrier component from at least one non-cellular network, wherein the at least one non-cellular network is distinct from the cellular network, and instantiate the inter-operator carrier aggregation service in the cellular network for an endpoint device, wherein the inter-operator carrier aggregation service implements a carrier aggregation process utilizing the first carrier component from the at least one non-cellular network and a second carrier component from the cellar network to provide data transmission to the endpoint device.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for providing a dynamic on demand inter-operator carrier aggregation service; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for providing a dynamic on demand inter-operator carrier aggregation service. As discussed above, carrier aggregation is a technique used in wireless communications to increase a user endpoint device's data rate by assigning multiple component carriers (i.e., frequency blocks) to the same user endpoint device, effectively creating a wider channel for data transmissions. The greater the number of component carriers assigned to the user endpoint device, the wider the channel, and, consequently, the greater the increase in the maximum possible data rate the user endpoint device experiences. Thus, carrier aggregation can boost the throughput to the user endpoint device, while also reducing the latency that may affect the user endpoint device. To illustrate, carrier aggregation may take place between two or more wireless bands such as band 2 (e.g., 1900 MHz) and band 66 (e.g., 1700 Mhz Extended AWS). However the trigger for the use of such carrier aggregation is pre-defined (i.e., set beforehand) by the operator of the mobile communication network. In other words, the set of conditions or criteria that will trigger the use of carrier aggregation of band 2 and band 66 to support subscriber endpoint devices within the mobile communication network are predefined by the operator of the mobile communication network.

Furthermore, carrier aggregation is often utilized by a single operator of a single communication network (e.g., a single mobile carrier or operator) to provide multiple component carriers that are within the direct control of the single operator to support its subscribers. More specifically, the carrier components are within the control of the single operator of the mobile communication network at a particular geographic location. Said another way, band 2 and band 66 are allocated solely for use by the mobile communication network. Thus, such predefined conditions or criteria have limited the full potential capability of the 5G/6G eco system in terms of the lightning speeds that the technologies have potentially promised.

In accordance with the present disclosure, examples of the present system are able to dynamically provide not only carrier aggregation of carrier components allocated to a single cellular operator, but carrier aggregation of carrier components allocated to a plurality of disparate operators of disparate networks utilizing different communication technologies (broadly non-cellular technologies) distinct from the cellular network. In other words, carrier components from 1) cellular communication networks, 2) WiFi communication networks, 3) fiber optic communication networks with access points; 4) non-terrestrial networks (NTNs) (e.g., NTNs include satellite communication networks and communication networks that utilize unmanned aerial vehicles or high-altitude platform systems to provide broadband links), 5) acoustic communication networks (e.g., networks that use sound waves to transmit information between devices or sensors), and/or 6) thermal communication networks (e.g., networks that use thermal noise to transmit information between devices or sensors), can all be dynamically aggregated to support one or more user or subscriber endpoint devices. Thus, the present disclosure provides new modes of communications that is transport agnostic, e.g., providing dynamic on demand inter-operator carrier aggregation.

Furthermore, the present disclosure provides a predictive mechanism that allows the dynamic on demand inter-operator carrier aggregation to be implemented or triggered dynamically based on the current demand on the current cellular communication network and/or the demand of a particular subscriber endpoint device. This predictive mechanism allows a new service (e.g., a premium service) to be provided to a subscriber of a cellular communication network as a subscription to a quality of service (QoS) enhancer service, thereby enhancing the experience of the subscriber and also generating a new revenue stream for the operator of the cellular communication network.

In an illustrative example of the present disclosure, in response to a current demand on a cellular communication network and/or the demand of a particular subscriber endpoint device supported by the cellular communication network, dynamic on demand inter-operator carrier aggregation can be triggered, i.e., using carrier aggregation of carrier components that are allocated to a plurality of different disparate networks utilizing different technologies. In one embodiment, a cellular network may instantiate/create a new network slice to handle the dynamic on demand inter-operator carrier aggregation service.

In one example, the new network slice may implement a specific routing to one or more network functions (NFs), such as a carrier aggregation manager (CAM) system/tool to look more closely at the traffic to provide the necessary coordination to implement the present dynamic on demand inter-operator carrier aggregation, e.g., to account for the potential transport delays that may occur in using different carrier components from different types of communication networks. For example, data that is transported on a fiber optic communication network with access points may arrive at an aggregation point (broadly a processing point) of a cellular core network significantly faster than data that is transported on a WiFi communication network. Thus, the carrier aggregation manager(s) may need to execute the necessary coordination to ensure that the data transported by the carrier aggregation mechanism can be properly processed at a remote aggregation point.

In addition, the cellular network may de-provision/de-instantiate the new network slice. Similarly, examples of the present disclosure may also be used in connection with a network overload condition or other demands. For example, the new network slice may include additional resources, may have a different physical or logical topology that may avoid network infrastructure that is affected by a power outage, faulty hardware, or faulty software configurations (e.g., at a device level rather than at a slice/system level), and so forth.

In accordance with the present disclosure, following the detection of a need to provide a dynamic on demand inter-operator carrier aggregation service for a subscriber, a new network slice may be created with different characteristics in attempt to provide better performance. After continued observation, the cellular network may determine if network conditions are the same, better, or worse. If network conditions are not better, the cellular network can iteratively attempt to change the network slice characteristics using trial and error, e.g., reinforcement learning (RL), or the like until an optimal and/or satisfactory set of characteristics is found.

In various examples, the present disclosure may incorporate artificial intelligence (AI)/machine learning (ML) processes to automate and accelerate responses to the need to provide the dynamic on demand inter-operator carrier aggregation service, thereby providing a more reliable and higher performance network service to endpoint devices/subscribers. In one example, the use of 5G standards-based network slicing may solicit broad vendor support and interoperability to implement the mechanics of the dynamic on demand inter-operator carrier aggregation of the present disclosure. Notably, a cellular network may utilize network slicing, e.g., as described/defined in 3GPP technical standard (TS) 23.501, and may therefore be comprised of many slices, each with different characteristics. In addition, such a cellular network may include a slice orchestrator, such as described in 3GPP TS 28.530 and/or 28.531.

In one example, the slice orchestrator may include a provisioning module, which interacts with the cellular network (e.g., the NFs and/or network elements, host devices, etc.) to provision, instantiate, and/or deploy network slices, and an inventory module which tracks and reports on slices that are currently in operation. For instance, the slice orchestrator may be configured to observe the real-time health of the network (including the slices thereof) and endpoint device performance, such as measurements of network and slice-specific performance and health. To further illustrate, this may include monitoring of various network performance indicators, e.g., “key performance indicators” (KPIs), such as control indicator logs, e.g., “key control indicator” (KCI) logs, alarms/alerts, and so forth. In one example, the slice orchestrator may further include an artificial intelligence (AI)/machine learning (ML)-based module that may obtain, inspect, and analyze user plane data traffic (e.g., packets, frames, datagrams, etc.) for performance anomalies. In one example, the inventory module may generate and maintain a network model based on real-time/current and historic topology and observations. In one example, the AI/ML-based module, or AI/ML module, may include a rules engine with pre-provisioned instructions on how to handle performance anomalies. In one example, users/subscribers may opt-in to the additional slice-based dynamic on demand inter-operator carrier aggregation services in accordance with the present disclosure. In one example, the provisioning module may include a generative model, e.g., another ML-based module that may interact with the inventory module to capture a view of the current state of the network and that may determine a recommended configuration/characteristics for a new network slice.

In one example, in response to a particular network state (e.g., a performance impacting anomaly condition), the slice orchestrator may create a new dynamic slice, which may closely match the characteristics of the existing slice, but with enhancements in an attempt to resolve the network performance anomaly. In addition, one or more endpoint devices may be moved to the new network slice supporting dynamic on demand inter-operator carrier aggregation. In one example, the network orchestrator may make automatic updates to the network model based on continued observation following the change to the new slice. In one example, the network orchestrator may further employ a feedback loop based on continual traffic inspection and performance anomaly detection, e.g., to determine whether the new network slice resolves a performance anomaly and/or better meets one or more user service requirements. In one example, the slice orchestrator may update the new network slice and/continue to instantiate one or more additional new network slices to test the configurations for improvements and/or resolution of the anomalous conditions, e.g., testing different combinations of carrier component aggregation from different operator networks. In one example, the network orchestrator may further make a decision of whether to revert back to the original slice or move forward with the new network slice on a more permanent/long term basis. In addition, the network orchestrator may de-instantiate the slice when it is no longer needed, e.g., when the performance anomaly is resolved.

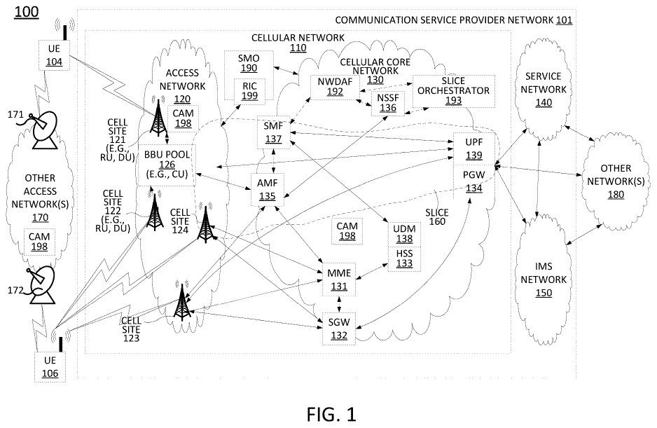

Examples of the present disclosure may also be used to provide more reliable and higher-performing service to public safety entities and users having one or more dedicated slices. For instance, examples of the present disclosure may provide a network slice to support critical traffic (e.g., first responder traffic) and to formulate further response actions in a more controlled environment. Furthermore, performance anomalies or other anomalies may be addressed by the proper selection of different combinations of carrier component aggregation from different operator networks, e.g., a first combination of carrier component aggregation using carriers from a cellular communication network and a WiFi communication network (a non-cellular network) for a first type of performance anomaly, a second combination of carrier component aggregation using carriers from a cellular communication network and a fiber optics communication network (a non-cellular network) for a second type of performance anomaly, a third combination of carrier component aggregation using carriers from a cellular communication network and a non-terrestrial communication network (a non-cellular network) for a third type of performance anomaly, and so on. These and other aspects of the present disclosure are discussed in greater detail below in connection with the examples of FIGS. 1-3.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In an Open RAN (O-RAN) architecture, these may alternatively or additionally be referred to as and/or may include radio units (RUs) (also referred to as O-RUs) and/or distributed units (DUs). In one example, the BBU pool 126 may be located at distances as far as 20-80 kilometers or more away from the antennas/remote radio heads of cell sites 121 and 122 that are serviced by the BBU pool 126. In an O-RAN architecture, these may alternatively or additionally be referred to as and/or may include centralized units (CUs). It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN and or O-RAN infrastructure may include radio units (RUs)/RRHs, distributed units (DUs), and centralized units (CU) (e.g., where baseband units (BBUs) may include CUs and/or CUs in conjunction with DUs), a heterogeneous network may include cell sites where RRH and BBU components (or CUs, DUs, and RUs) remain co-located at the cell site. For instance, cell site 123 may include RRH and BBU components (or an RU, DU, and CU). Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas. In accordance with the present disclosure, a base station may comprise one of cell sites 121-123. Alternatively, or in addition, a base station may comprise one of baseband units within BBU pool 126 or a portion thereof (e.g., a CU, a DU, or a CU in conjunction with a DU), or a BBU of BBU pool 126 in conjunction with an RU or RRH of one of cell sites 121-123.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126. In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-124. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and any future generation of wireless cellular technology, e.g., 6G the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, and a network data analytics function (NWDAF) 192.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

As noted above, cellular core network 130 further includes NWDAF 192, which may be tasked with monitoring various network functions, network slices, and access network components. In one example, NWDAF 192 may subscribe to data analytics (e.g., performance indicators/KPIs, and more specifically, measurements/values thereof) from a variety of NFs, may store these analytics, and may provide such analytics to other NFs that may request such data. In accordance with the present disclosure, NWDAF 192 may track various performance indicators with respect to cellular core network 130 and/or regarding particular components thereof (such as SMF 137, AMF 135, UPF 139, etc.) and with respect to access network 120 and/or regarding particular components thereof (such as RUs, DUs, CU, etc., e.g., cell sites 121 and 122, BBU pool 125, cell sites 123 and 124, and so forth). In one example, NWDAF 192 may also collect and store external/third-party data, such as weather data (e.g., temperature, humidity, precipitation indication, precipitation volume, etc.) that may also be used in connection with detecting and/or predicting/forecasting anomalies, such as network impairments, quality of service (QoS) degradation, security issues, etc. relating to cellular network 110 and/or particular portions thereof.

To further illustrate, NWDAF 192 may store or may have access to a database system that may store various types of information in connection with examples of the present disclosure. For example, NWDAF 192 may be configured to receive and store network topology data, including the type(s) of network resources/network elements (e.g., both physical and virtual), the locations of such network resources, the connectivity between resources, the allocation of such resources to sub-nets, tracking areas, or the like, and so forth. In one example, the network topology information/data may include or may be cross-referenced to network inventory data, such as, for physical network resources, the manufacture date, the purchase date, the deployment date, the last serviced date and/or a service history, identities of the service technician(s), an incident/event list (e.g., for past network events associated with the network resource), a serial number, a model number, a version number, a software version, and so forth. In one example, the network topology data may comprise a network graph, or network graph database. For instance, nodes in the graph/graph database may represent network resources, network zones, etc., where some links/edges may represent physical links, or logical paths over physical links, while other links/edges may represent logical relationships, such as a virtual network function (VNF) being instantiated on a particular network function virtualization infrastructure (NFVI) physical element, a network resource being a component of a particular sub-net or tracking area, etc.

In addition, NWDAF 192 may be configured to receive and store network operational data, including performance indicator data (e.g., “key performance indicators” (KPIs)), such as: utilization and/or availability levels of network resources, configuration settings and/or parameters of such network resources, alarm data, and so forth. For instance, such data may be collected from various NFs (e.g., physical or virtual) reporting to NWDAF 192, such as routers, RAN elements, cellular core network components, storage servers, content distribution network nodes, subscribers'endpoint devices, etc. In this regard, it should be noted that in one example, cellular network 110 may also include one or more aggregator devices for collecting performance data (e.g., KPIs) and/or configuration data for various network elements/network functions and/or zones, regions, tracking areas, etc. of cellular network 110. For instance, such aggregator device(s) may collect performance indicators and/or configuration data over a period of time, and may then provide a batch report and/or aggregated records to NWDAF 192.

It should be noted that some or all of such information (network topology and/or network operational) may be contained in other network databases/systems, such as one or more of an active and available inventory (A&AI) database, a network inventory database, a call detail records (CDR) repository, or the like. Alternatively, or in addition, NWDAF 192 may be configured to receive and store customer/subscriber network service information (e.g., an additional type or types of network operational data), such as the subscriber/customer identities and other characteristics, a customer segment as described herein), service level agreement (SLA) thresholds, and so forth. In one example, aspects of the abovementioned data may be stored in user, subscriber, and/or account profiles, which may include account owner biographic information, such as individual or entity name, address, phone number(s), device identifier(s), authorized users, age(s), service history, payment history, payment methods, communication preferences, privacy preferences, and so forth. In other words, some of the abovementioned data types may be stored in or linked to respective user/account profiles, or the like. Similar to the above, some or all of such information may be contained in other network databases/systems, such as one or more of an authentication, authorization, and accounting (AAA) server/system, an operations support system (OSS), a business support system (BSS), a unified data repository (UDR), or the like.

It should be noted that in accordance with the present disclosure, the network topology information/data and/or network operational data stored by NWDAF 192 or elsewhere may be maintained over a period of time. For instance, NWDAF 192 may store respective time series data indicative of different states of a network topology, different utilization and/or assignment levels of various network resources of various types in a given time interval (and over a period of a plurality of time intervals), etc. In one example, data may be segregated by customer segment, network zone, geographic region, and so forth.

In one example, NWDAF 192 may alternatively or additionally receive and store data from one or more external data feeds. For instance, NWDAF 192 may receive and store geographic data, e.g., from one or more external services, such as a geographic information system (GIS), which may include digital map data such as geo-political boundary maps, terrain maps, and so forth. Alternatively, or in addition, NWDAF 192 may receive and store weather data from a device of a third-party, e.g., a weather service, a traffic management service, etc. For instance, the weather data may be received via a weather service data feed from a weather data server (WDS), e.g., a National Weather Service (NWS) extensible markup language (XML) data feed, or the like. In another example, the weather data may be obtained by retrieving the weather data from the WDS. In one example, NWDAF 192 may receive and store weather data from multiple third-parties, which can then be correlated to network traffic data to reflect impact of various weather conditions on overall network traffic and/or network traffic for specific UEs/endpoint devices, classes of endpoint devices, etc. In still another example, NWDAF 192 may obtain and store various vehicular traffic related data, e.g., from a 3^{rd} party vehicular traffic data server, such as toll payment data, records of traffic volume estimates, traffic signal timing information, and so forth. Similarly, NWDAF 192 may obtain event notifications from a server of an entertainment event notification service (e.g., a Really Simple Syndication (RSS) feed or the like). For instance, NWDAF 192 may obtain one or more data sets/data feeds comprising information such as: notifications of mass sporting events, concerts, parades, civic gatherings, etc., including location information, time and duration information, expected attendance, and so forth.

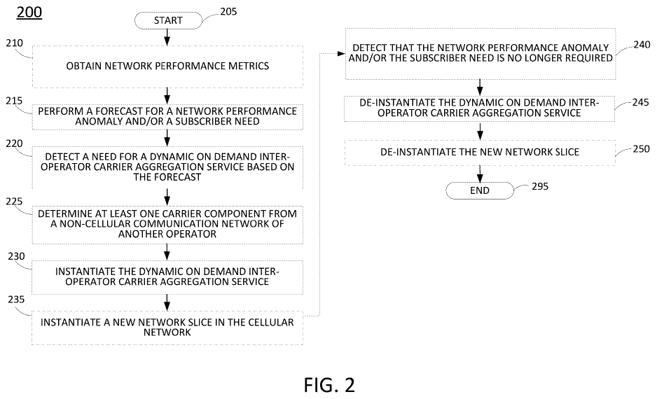

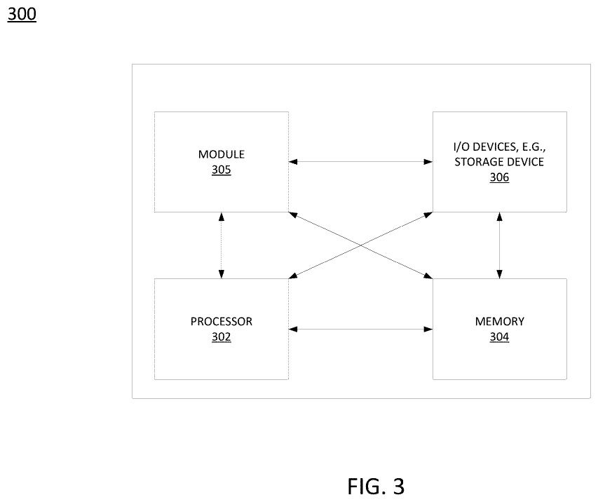

In one example, carrier aggregation manager 198 may comprise all or a portion of a computing device or system, such as computing system 300, and/or processing system 302 as described in connection with FIG. 3 below, and may be configured to perform various operations in connection with examples of the present disclosure for supporting dynamic on demand inter-operator carrier aggregation of the present disclosure (e.g., as illustrated and described in connection with the example of FIG. 2). In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, CAM 198 may also train and store one or more network performance anomaly detection/forecasting models. For instance, the network performance anomaly detection/forecasting model(s) may each comprise a machine learning model. It should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may further be enhanced with domain-specific training data.

In one example, MLMs of the present disclosure may include an ML-based generative model, such as a language model, e.g., a “large language model” (LLM). For instance, an ML-based generative model used in the present examples may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. For instance, a generative model, such as one of the foregoing, may be trained/configured to generate decisions for implementing dynamic on demand inter-operator carrier aggregation for a subscriber and/or in response to a network performance anomaly. For example, the present system may implement dynamic on demand inter-operator carrier aggregation for a subscriber (or subscribers) via a new network slice in response to a subscriber's need (e.g., bandwidth need, data processing speed need, data transmission speed need, data transmission reliability need, etc.) or demand for network resources, a network performance anomaly, the type of network performance anomaly, and/or the severity of the network performance anomaly. In one example, the present disclosure may fine-tune a LLM to provide high-level instructions for radio access network (RAN)/cellular network-specific issues. In addition, in one example, the present disclosure may further enhance such a fine-tuned MLM to provide concrete, actionable instructions, e.g., a network slice configuration (e.g., comprising NFs, processor, memory, storage, or other resources/capabilities of such NFs etc., connections between NFs, configuration setting/parameter values, and so forth) and/or the selection of a particular type of carrier aggregation for dynamic on demand inter-operator carrier aggregation for a subscriber. For instance, a generative LLM of the present disclosure may further include a retrieval augmented generation (RAG) process loop to index network equipment and/or network function vendor documentation, network operator internal documents, cellular technology technical standards, such as 3rd Generation Partnership Project (3GPP) technical standards (TS), or the like in a vector store, as well as current network and/or slice status information. In one example, input data for such a LLM-based generative model may include converting categorical or numerical data to text form, as well as vectorization of textual data to vectors (e.g., via word2vec, doc2vec, Global Vectors for Word Embedding (GloVe), or the like, using n-grams, and so forth). In one example, tailored prompts may be used in connection with a generative MLM of the present disclosure, e.g., to obtain outputs that may comprise instructions in useable format with respect to other network functions, such as outputs formatted for simple network management protocol (SNMP)-based communications or the like.

In one example, NWDAF 192 or CAM 198 may train and deploy one or more such network performance anomaly detection/forecasting models. For instance, a first MLM may be used to detect a video service quality degradation, a second MLM may be used to detect a potential congestion condition based on the trajectories of a plurality of subscriber endpoint devices converging on a particular location serviced by a particular cell site, a third MLM may be used to detect gaming activities associated with virtual reality gaming resource requirements for a particular location or a particular endpoint device, etc. Likewise, NWDAF 192 or CAM 198 may train and deploy different network performance anomaly detection/forecasting models for different geographic regions (e.g., states, groups of states, etc.), for different tracking areas, for different equipment types, for different deployment types (e.g., rooftop versus non-rooftop/standalone), and so on. Alternatively, or in addition, these factors may comprise additional inputs/predictors for a trained MLM, where the MLM may learn and generate outputs based upon the relevance of these different inputs/predictors.

To further illustrate, in one example, NWDAF 192 or CAM 198 may apply an input vector comprising data traffic information associated with at least a portion of the cellular network 110 (and/or associated with one or more endpoint devices/UEs to which cellular network 110 provides one or more network services) to a network performance anomaly detection/forecasting model to generate an output indicating whether a portion of the cellular network is experiencing and/or is predicted to exhibit a potential performance anomaly, e.g., an anomalous performance condition (e.g., significant latency, dropped sessions, constrained bandwidth, etc.), at a future time period. In this regard, it should be noted that in one example, such a network performance anomaly detection/forecasting model may be trained/configured to output an indicator of whether a particular type of performance anomaly is detected and/or forecast. In one example, the input vector may comprise data traffic information associated with a first network slice, such as slice 160 illustrated in FIG. 1 (e.g., cell site 124, comprising AMF 135, SMF 137, and UPF 139). In one example, the data traffic may comprise information that may include packet information for one or more packets, such as packet header information, timing information, packet size/data size, etc., flow information, such as a number of packets, a total data volume and/or data volume per unit time, packet timing information (e.g., spacing, uniformity/regularity, etc.), and so forth.

In one example, the data traffic information of such an input vector may be with respect to a particular data traffic flow, a particular endpoint device/UE, a particular subscriber/entity, or multiple endpoint devices/UEs, such as those attached to a particular sector or cell site, those in a particular tracking area, etc., endpoint devices/UEs of a particular category (e.g., make, model, etc.) or class, e.g., service tiers/QoS classes, etc., and so forth. In one example, the input vector may further include or may be accompanied by network configuration data (e.g., topology, one or more configuration setting value(s), and/or one or more performance indicator metrics/values). For instance, this supplemental input data may further inform and improve the accuracy of a network anomaly detect/forecasting model. For instance, a large number of network attach requests from UEs at a particular location may indicate a DDoS attack, a large sporting event, or a concert event, but may also indicate that there is a misconfiguration with an AMF, such as AMF 135, for example. In this regard, status information from AMF 135 may help the MLM to determine whether a security anomaly or a network performance anomaly is or is not exhibited in the data. Conversely, such status information may help to inform the same or a different MLM that a service degradation is occurring in the network slice 160 in which AMF 135 is deployed.

In any case, NWDAF 192 or CAM 198 may identify network performance anomalies/anomalous conditions in network slice 160 using one or more trained MLMs, e.g., network performance anomaly detection/forecasting models. In one example, NWDAF 192 or CAM 198 may implement collaborative models, e.g., a pipeline of MLMs, or the like for an overall purpose. For instance, a first MLM may predict a number of endpoint devices that may be present in a given area (e.g., at a cell site) at a future time period, while a second MLM may predict whether a network performance impairment (e.g., a network performance anomaly/anomalous condition) may be exhibited at such time future period, e.g., based at least in part upon the number of endpoint devices predicted via the first MLM such that dynamic on demand inter-operator carrier aggregation may be needed to support these endpoint devices in the future time period.

In one example, NWDAF 192 or CAM 198 may further be configured to determine responses to network performance anomalies/anomalous conditions. For instance, in accordance with the present disclosure, NWDAF 192 or CAM 198 may determine that dynamic on demand inter-operator carrier aggregation should be implemented for a region or a set of one of more subscriber endpoint devices. In one embodiment, NWDAF 192 or CAM 198 may further determine the necessary resources to support the dynamic on demand inter-operator carrier aggregation, e.g., a new network slice is to be instantiated in response to a performance anomaly/anomalous condition. In one example, NWDAF 192 or CAM 198 may further determine one or more characteristics of the new network slice that is to be instantiated, such as the number and types of NFs, the locations and/or hardware type of host devices supporting the NFs, the links between NFs, the link bandwidth(s), packet routing/data traffic handling specifications, the UEs, endpoint device type(s), classes, etc. to be assigned to the new network slice, and so forth. More importantly, NWDAF 192 or CAM 198 will also determine the selection of the carrier components necessary to support the dynamic on demand inter-operator carrier aggregation.

To illustrate, FIG. 1 also illustrates an “other” access network 170 having transceivers or access points 171 and 172. These transceivers or access points 171 and 172 are for a plurality of different types of communication networks distinct from the cellular core network 130. The plurality of different types of non-cellular communication networks may comprise: 1) WiFi communication networks, 2) fiber optic communication networks with access points; 3) non-terrestrial networks (NTNs) (e.g., NTNs include satellite communication networks and communication networks that utilize unmanned aerial vehicles or high-altitude platform systems to provide broadband links), 4) acoustic communication networks (e.g., networks that use sound waves to transmit information between devices or sensors), and/or 5) thermal communication networks (e.g., networks that use thermal noise to transmit information between devices or sensors). When NWDAF 192 or CAM 198 determines that dynamic on demand inter-operator carrier aggregation is necessary to be implemented, one or more carrier components from these other communication networks will be aggregated with at least one carrier component of the cellular access network 120.

In one example, NWDAF 192 or CAM 198 may be equipped within one or more rules, e.g., decision trees, process flows, etc. which may indicate the type of carrier aggregation to be implemented including optionally the need for a new network slice and/or its characteristics. Alternatively, or in addition, NWDAF 192 or CAM 198 may determine a response, e.g., a decision to instantiate a new network slice, and/or a determination of the network slice type and/or characteristics of the new network slice, via an additional MLM that may be configured to generate an output comprising information regarding the new network slice (e.g., a network slice configuration) in response to an input vector comprising network performance anomaly information associated with the network performance anomalous condition. In one example, the network performance anomaly information may include a set of packet information and/or network performance anomaly/alarm information that may be derived from the set of packet information, e.g., via one or more rules and/or a first MLM for network performance anomaly detection/forecasting implemented at a prior stage. In one example, the determination of the recommended configuration of the new network slice may be via a generative MLM such as mentioned above.

In one example, NWDAF 192 or CAM 198 may further cause the new network slice to be instantiated and one or more endpoint devices to be migrated to the new network slice. For instance, NWDAF 192 or CAM 198 may transmit instructions to one or more host devices to reserve resources and to cause a new vSMF, vAMF, and vUPF to be instantiated thereon, to cause interfaces and links between these NFs to be established, and so forth. In one example, NWDAF 192 or CAM 198 may also transmit instructions to NSSF 136, which may cause NSSF 136 to designate particular endpoint devices/UEs, classes of endpoint devices, or the like to be assigned to the new network slice and/or also the selection of at least one carrier component from the other access network 170 to be aggregated with a carrier component of access network 120.

In addition, NWDAF 192 or CAM 198 may continue to monitor the network state of cellular network 110, e.g., including processing data traffic information for the new network slice and/or supplemental data (such as network topology and/or network status information) to detect network performance anomalies (and/or to confirm that a network performance anomaly type exhibited by slice 160 is not exhibited in the new network slice), to determine whether performance of the new network slice is superior to the performance of slice 160, e.g., according to one or more network performance metrics, and so forth.

In one example, NWDAF 192 or CAM 198 may alternatively or additionally transmit instructions to de-instantiate the dynamic on demand inter-operator carrier aggregation service and/or the old network slice (e.g., slice 160). However, it should be noted that in one example, network slice 160 may remain in operation and only a portion of the endpoint devices/UEs may be migrated to the new network slice. Then, NWDAF 192 or CAM 198 may monitor the performance of both the old slice and the new slice to determine which is performing better. If there is no improvement or a worsening of performance, the new network slice may be de-instantiated and endpoint devices/UE may be assigned back to the slice 160. Similarly, in one example, the use of the dynamic on demand inter-operator carrier aggregation service may be temporary, and endpoint devices/UEs may be assigned back to the original carrier component (or components) when a performance anomaly is resolved (e.g., proactively by the communication service provider network 101 through manual troubleshooting or other automated systems, and/or via natural resolution of a root cause, such as the ending of a mass gathering event which may cause a large number of users/UEs to disperse, etc.).

Alternatively or in addition, NWDAF 192 or CAM 198 may provide individual or aggregate reports to one or more other NFs, e.g., on a subscription basis and/or on-demand. For instance, SMO 190 and/or RIC 199 thereof may obtain network performance anomaly alerts, reports, or the like from NWDAF 192 or CAM 198, and may use such information to automatically configure/reconfigure one or more aspects of access network 120 and/or cellular core network 130. Similarly, a slice orchestrator 193 may obtain network performance anomaly alerts, reports, or the like from NWDAF 192 or CAM 198, and may use such information to automatically configure/reconfigure one or more aspects of access network 120 and/or cellular core network 130, e.g., instantiating new network slices, de-instantiating network slices, instantiating a dynamic on demand inter-operator carrier aggregation service, or de-instantiating the dynamic on demand inter-operator carrier aggregation service, etc. Alternatively, or in addition, NWDAF 192, CAM 198, and/or SMO 190 may determine that a response to a network performance anomaly should include actions relating to network slicing and/or dynamic on demand inter-operator carrier aggregation, and may instruct the slice orchestrator 193 accordingly. It should be noted that aspects of the presented disclosure described above with respect to NWDAF 192 or CAM 198 may alternatively or additionally be performed by or deployed to SMO 190 and/or RIC 199, and similarly with respect to slice orchestrator 193. In this regard, in one example, slice orchestrator 193 may determine characteristics of the new network slice and may instruct or request SMO 190 and/or RIC 199 to reserve resources of access network 120 and/or cellular core network 130 accordingly. Then, slice orchestrator 193 may further communicate with such NFs to instruct these NFs to implement particular configurations (e.g., configurable setting/parameter values). In addition, in such an example, the slice orchestrator 193 may communicate with NSSF 136 to indicate that the new network slice is available to support the dynamic on demand inter-operator carrier aggregation service and is ready for use, to indicate particular endpoint devices/UE, classes of endpoint devices, or the like to assign to the new network slice, to change one or more slice assignment rules for assigning UEs to the old network slice (e.g., reducing the number or type(s) of UEs allowed to attach to slice 160 through access class blocking, etc.), and so forth. In one example, the slice orchestrator 193 may alternatively be another component/module of the SMO 190.

Furthermore, although a single CAM 198 is illustrated as being deployed within the cellular core network 130 in one example, the functions performed by CAM 198 can be implemented elsewhere (e.g., via a plurality of CAMs 198). For example, the functions performed by CAM 198 can be implemented in access network 120 and the other access network 170 so that a plurality of CAMs may operate in a coordinated manner, i.e., a cluster of CAMs in a region may coordinate together to implement the present dynamic on demand inter-operator carrier aggregation service. For example, the CAM 198 of access network 120 of a cellular network may coordinate carrier aggregation with CAM 198 of other network 170, e.g., a WiFi access network, to service the data transmission need of subscriber UE 104. It should be noted that this “cluster” of CAMs 198 may also communicate with each other to share performance metrics of its own respective network, e.g., data packet transport speed, bandwidth availability, dropped packet rate, etc. Using such shared performance metrics, each CAM 198 will be able to ascertain an estimated delay that may occur due to the difference in data transport speed between the different networks. This estimated delay can be accounted for by each CAM 198 so that the aggregated data streams from the different carrier components will be received at the aggregation point as close in time as possible to minimize the need for buffering and/or data retransmission requests (e.g., the processor at the aggregation point may erroneously believe that some data packets were dropped or lost so that retransmission of those delayed packets is requested).

Furthermore, although the aggregation point (e.g., the point in which the plurality of different data streams from the different carrier components are received and processed) is illustrated as being deployed, e.g., within CAM 198 in the cellular network core 130, the aggregation point could in fact be deployed in a peer mobility network, e.g., within other networks 180. Thus, the processing of the aggregated data streams can be processed by a peer mobility network and the revenue derived from providing the present premium service can be shared with other peer mobility operators.

In one example, cellular network 110 may comprise a “non-stand alone” (NSA) mode architecture, where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, in another example, the present disclosure may relate to a hybrid, or integrated 4G/LTE-5G cellular core network, such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

FIG. 1 also illustrates various mobile endpoint devices, e.g., user equipment (UE) 104 and 106. UE 104 and 106 may each comprise a cellular telephone, a smartphone, a tablet computing device, a laptop computer, a pair of computing glasses, a pair of wireless goggles, a wireless enabled wristwatch, a wireless transceiver for a fixed wireless broadband (FWB) deployment, or any other cellular-capable mobile telephony and computing devices (broadly, “a mobile endpoint device”). In one example, each of the UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of the UE 104 and UE 106 may also include a gyroscope and compass to determine orientation(s), a global positioning system (GPS) receiver for determining a location, and so forth. Each of the UE 104 and UE 106 may also include the appropriate applications and transceivers to interact with the transceivers of access points 171 and 172 of the other access network 170. As illustrated in FIG. 1, UE 104 may access wireless services via the cell site 121 and access point 171, while UE 106 may access wireless services via any of cell sites 122-124 located in the access network 120 and access point 172.

As illustrated in FIG. 1, UEs 104 and 106 may register and attach to any of cell sites 121-124 to obtain network services from cellular network 110 and/or communication service provider network 101. This may include detecting a primary synchronization signal (PSS), secondary synchronization signal (SSS), physical broadcast channel (PBCH), and/or demodulation reference signal (DMRS), engaging a random access channel to report to the selected cell site and establish a radio resource control (RRC) communication, transmitting a registration/attach request, performing authentication procedures, establishing a default protocol data unit (PDU) session, e.g., including bearer assignment, and so forth.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NWDAF 192, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular network 110 may also include a service and management orchestrator (SMO) 190. For instance, in one example, SMO 190 may comprise a self-optimizing network (SON) orchestrator and/or software defined network (SDN) controller. To illustrate, SMO 190 may function as a self-optimizing network (SON) orchestrator that is responsible for activating and deactivating, allocating and deallocating, and otherwise managing a variety of network components. For instance, SMO 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SMO 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node, such as a virtual AMF (vAMF), a virtual SMF (vSMF), a virtual UPF (vUPF), etc. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SMO 190 may be connected directly or indirectly to any one or more network elements of cellular core network 130, access network 120, and of the system 100 in general. Due to the relatively large number of connections available between SMO 190 and other network elements, none of the actual links to the SON/SDN controller 190 are shown in FIG. 1. Similarly, intermediate devices and links between MME 131, SGW 132, cell sites 121-124, PGW 134, AMF 135, NSSF 136, SMF 137, UDM 138, NWDAF 192, and/or UPF 139, and other components of system 100 are also omitted for clarity, such as additional routers, switches, gateways, and the like.

In one example, SMO 190 may include a RAN intelligent controller (RAN-IC or RIC) 199. For instance, in an O-RAN architecture, the RIC 199 may be deployed for managing and controlling various RAN components/functions, e.g., CUs, DUs, and RUs. For instance, RIC 199 may comprise a platform that hosts various RAN applications (e.g., xApps/rApps) that may be used to configure and reconfigure various components of access network 120. In one example, aspects of RIC 199 may represent functionality of an SON orchestrator, or vice versa. In one example, RIC 199 and/or SMO 190 may request and/or subscribe to various information that may be obtained and stored by NWDAF 192. Such information may include time-stamped RAN performance indicators (e.g., KPIs for various time blocks/intervals), RAN environment state information (e.g., RAN parameters and/or settings associated with the time blocks/intervals for which performance indicators may be measured/collected), or the like. Alternatively, or in addition RIC 199 and/or SMO 190 may obtain various information from RAN components or other network elements directly (e.g., without NWDAF 192 as an intermediary). In one embodiment, the functions of CAM 198 can be implemented by RIC 199.

In one particular example, as noted above SMO 190 may subscribe to or otherwise obtain network performance anomaly alerts, reports, or the like from NWDAF 192 or CAM 198. In such case, SMO 190 and/or RIC 199 may then implement one or more rule sets and/or MLMs to determine whether and when to instantiate dynamic on demand inter-operator carrier aggregation and/or a new network slice, to determine the type of dynamic on demand inter-operator carrier aggregation and/or the network slice and/or characteristics of the new network slice, etc. Accordingly, SMO 190 and/or RIC 199 may then configure/reconfigure one or more aspects of access network 120, cellular core network 130, and/or one or more network slices deployed over the infrastructure of access network 120 and cellular core network 130, e.g., to implement the dynamic on demand inter-operator carrier aggregation on a particular slice. In one example, SMO 190 and/or RIC 199 may accomplish this directly, e.g., without involvement of slice orchestrator 193. Alternatively, SMO 190 and/or RIC 199 may instruct the slice orchestrator 193 to implement the new network slice, where slice orchestrator 193 may communicate with NFs of access network 120 (e.g., gNBs, etc.) and/or of cellular core network 130 (e.g., AMFs, SMFs, UPFs, etc.) to reallocate resources to accommodate the new network slice.

In one example, RIC 199 and/or SMO 190 may comprise all or a portion of a computing device or system, such as computing system 300, and/or processing system 302 as described in connection with FIG. 3 below, and may be configured to perform various operations in connection with examples of the present disclosure for instantiating dynamic on demand inter-operator carrier aggregation (e.g., as illustrated and described in connection with the example of FIG. 2). In this regard, it should again be noted that in some examples, aspects described herein with respect to NWDAF 192 or CAM 198 may alternatively or additionally be performed by SMO 190 and/or RIC 199. Likewise, it should be further noted that aspects above with respect to SMO 190 and/or RIC 199 may alternatively or additionally be performed by or deployed to slice orchestrator 193 (or slice orchestrator 193 may comprise a component of the SMO 190). Thus, slice orchestrator 193 may also comprise all or a portion of a computing device or system, such as computing system 300, and/or processing system 302 as described in connection with FIG. 3 below, and may be configured to perform various operations in connection with examples of the present disclosure for instantiating dynamic on demand inter-operator carrier aggregation.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs).

In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. It should be noted that the example described above involves a 4G-to-5G PDN connection transfer (and 5G-to-4G reversion) that includes UE 106 transferring from cell site 124 to cell site 122 (and vice versa). However, in another example, UE 106 may establish a 4G session to a PDN via 4G/LTE components of cell site 123, and may be transferred to a 5G connection via 5G components of the same cell site 123 in response to one or more trigger conditions as described above.

In addition, network elements or functions that are illustrating as being deployed in one portion of the communication service provider network 101 may alternatively or additionally be deployed in another portion of the communication service provider network 101. For example, SMO 190 may be deployed in cellular core network 130, within access network 120, or may comprise a distributed computing platform having hardware components within cellular core network 130 and access network 120. Thus, these and other modifications are all contemplated within the scope of the present disclosure.

FIG. 2 illustrates a flowchart of an example method 200 for instantiating dynamic on demand inter-operator carrier aggregation in response to a detected network performance anomalous condition and/or a subscriber's need or demand, in accordance with the present disclosure. In one example, steps, functions and/or operations of the method 200 may be performed by a device as illustrated in FIG. 1, e.g., a processing system comprising a NWDAF 192, a CAM 198, a slice orchestrator 193, a SMO 190 and/or a RIC 199, or the like, or collectively via a plurality devices in FIG. 1, such as NWDAF 192, CAM 198, slice orchestrator 193, SMO 190, RIC 199, or the like in conjunction with a different one of such components and/or any one or more other components in FIG. 1, such as components of access network 120 (e.g., cell sites 121-123, BBU pool 126, etc.) and/or other components of cellular core network 130 (e.g., NSSF 136, slice infrastructure, e.g., slice 160, ANF 135, SMF 137, UPF 139, etc.), and so forth. In one example, the steps, functions, or operations of method 200 may be performed by a computing device or system 300, and/or a processing system 302 as described in connection with FIG. 3 below. For instance, the computing device 300 may represent at least a portion of a NWDAF 192, CAM 198, slice orchestrator 193, SMO 190, RIC 199, etc. in accordance with the present disclosure. For illustrative purposes, the method 200 is described in greater detail below in connection with an example performed by a processing system, such as processing system 302. The method 200 begins in step 205 and may proceed to optional step 210 or to step 215.

At optional step 210, the processing system may obtain various network performance metrics as discussed above. For example, the processing system may generate a network model of a cellular network, where the network model may comprise a representation of a network state of the cellular network. In addition, the processing system may maintain the network model, e.g., updating the network model on an ongoing basis. To illustrate, the network state may comprise: a network topology, one or more network configuration setting values, and one or more performance indicator values/metrics (e.g., KPI values).

At step 215, the processing system performs a forecast of data traffic of a cellular network for a future time period, e.g., the forecast may detect a network performance anomaly and/or a subscriber need in the future time period. In one example, a data traffic inspection process may comprise applying a set of packet information for one or more packets to a machine learning model (MLM) (e.g., a network performance anomaly detection/forecasting model) implemented by the processing system that is configured to detect at least one type of network performance anomalous condition based upon the set of packet information and/or the needs of one or more subscribers (e.g., tracking the real time usage of subscribers'endpoint devices and their movement trajectories). For instance, the set of packet information may include packet header information of the one or more packets (e.g., source and destination IP addresses and ports, timing information, etc.). In accordance with the present disclosure, the one or more packets may be associated with one or more client endpoint devices (e.g., of a same customer or multiple subscribers/customers, or visiting endpoint devices/users (e.g., roaming or otherwise)). In one example, step 215 may include extracting the packet information from the one or more packets.

At step 220, the processing system detects a need for a dynamic on demand inter-operator carrier aggregation service (broadly an inter-operator carrier aggregation service) in response to detecting a potential network performance anomalous condition and/or a subscriber need based on the forecast of step 215. For instance, the detecting of the network performance anomalous condition may comprise detecting that one or more network performance indicator values exceed one or more threshold values, e.g., defined by one or more rules having fixed threshold values and/or formula-based thresholds defined by percentages and/or forecasts relating to past observations, trend data, or the like, e.g., 25% below or above a time weighted moving average, etc. Alternatively, or in addition, a network performance anomalous condition may be characterized in whole or in part by one or more conditions being true or false, or the like. In one example, the detecting of the network performance anomalous condition may be based on the data traffic inspection process and the network model comprising the network state of the cellular network. For instance, the network topology, configuration setting values, or other aspects of the network model (e.g., network state information) may be used as additional input(s) to the MLM of step 215. In this regard, it should be noted that in one example, the detecting of the network performance anomalous condition and/or subscriber need may include obtaining an output of the MLM of step 215, e.g., as a result of the data traffic inspection process.

At step 225, the processing system may determine at least one carrier component from a non-cellular communication network of another operator distinct from that of a cellular network operator for supporting the dynamic on demand inter-operator carrier aggregation service. In other words, at least one carrier component from at least one of the plurality of different types of non-cellular communication networks (e.g., WiFi communication networks, fiber optic communication networks with access points; non-terrestrial networks (NTNs) (e.g., NTNs include satellite communication networks and communication networks that utilize unmanned aerial vehicles or high-altitude platform systems to provide broadband links), acoustic communication networks (e.g., networks that use sound waves to transmit information between devices or sensors), and/or thermal communication networks (e.g., networks that use thermal noise to transmit information between devices or sensors)), will be selected to support the dynamic on demand inter-operator carrier aggregation service. Thus, at least one carrier component from at least one of the plurality of different types of communication networks will be used in conjunction with a carrier of a cellular communication network in a carrier aggregation process to support one or more subscriber endpoint devices, e.g., in one or more dedicated slices in a cellular core network. The selection of the types of communication networks to support dynamic on demand inter-operator carrier aggregation may depend on one or more factors such as the availability of the types of communication networks in a particular region, the type of network performance anomaly, the type of subscriber demand, the cost associated with utilizing the different types of communication networks, and so on.

Furthermore, step 225 may optionally include determining a network slice type of a new network slice. For instance, there may be predefined slice types with certain characteristics for different purposes. For example, a first slice type may comprise a general slice type that may be tailored to prevent UE blocking, but which may have bandwidth restrictions (e.g., number carriers per UE (e.g., no carrier aggregation, etc.) to ensure that basic connectivity is available for all). A second slice type may comprise a priority traffic handling slice, which may have additional priority network functions included in the cellular core network. Still other network slice types may be an ultra-reliable low latency communication (URLLC) slice type, a first responder slice type, and so forth. Alternatively, or in addition, step 225 may include determining one or more characteristics of the new network slice (e.g., the NFs, the processor, memory, storage, and other resource allocations of the NFs, the connectivity between the NFs (e.g., logical topology of the new network slice), the data traffic/call routing among the NFs, the security features of the slice (e.g., specific NFs and/or data traffic forwarding/routing, etc.), configuration settings of the NFs, e.g., power saving mode, beam steering/coverage, base station functional split, NF physical locations and/or particular host device locations, types, etc., and so forth). In one example, step 225 may include applying an input vector comprising network performance anomaly information associated with the network performance anomalous condition to a machine learning model that is configured to generate a response comprising information regarding the new network slice. For instance, the network performance anomaly information may include the set of packet information and/or network performance anomaly/alarm information that may be derived from the set of packet information, e.g., via one or more rules and/or as an output of a first MLM as in the preceding steps. In one example, an MLM used at step 225 may comprise a generative model/MLM, such as LLM that may be fine-tuned for cellular/RAN specific generative tasks, and/or which may have its performance enhanced via a retrieval augmented generation (RAG) process.

At step 230, the processing system instantiates the dynamic on demand inter-operator carrier aggregation service (e.g., on a new network slice) in the cellular network, in response to the network performance anomalous condition or subscriber need that is detected. Namely, the necessary network resources will be provisioned in the cellular network to implement the dynamic on demand inter-operator carrier aggregation service as discussed above. In one embodiment, the processing system will also assess a service charge to an account of the endpoint device, if the dynamic on demand inter-operator carrier aggregation service is provided as a premium service.

At optional step 235, in one example, a new network slice may also be instantiated based on applying an input vector comprising network performance anomaly information associated with the network performance anomalous condition to a machine learning model that is configured to generate a response comprising information regarding the need for implementing the dynamic on demand inter-operator carrier aggregation service in the cellular network. In one example, the input vector may further comprise: a network slice type of the first network slice and/or one or more characteristics of the first network slice. For instance, the MLM may be configured to generate the new network slice with similarities to the first network slice, but with one or more modifications that may address the network performance anomalous condition (e.g., malicious traffic, such as a detected virus, DoS attack, probing, or other malicious traffic, a network impairment, a network degradation, etc.). In a particular example in which the network performance anomalous condition comprises a security related issue, the new network slice may include security enhancements, such as a DPI system/tool to look more closely at the traffic, a scrubber to filter malicious traffic, a walled garden to quarantine traffic for one or more endpoint devices until an attack is over and/or endpoint device(s) is/are patched, and so forth. In one example, the new network slice may be configured to operate with specific routing/data traffic forwarding to include such device(s)/system(s) in a data traffic path, e.g., between a base station and UPF, or the like.

In one example, the information regarding the new network slice can be a network slice type and/or characteristics of the new network slice such as discussed in the foregoing. It should again be noted that there may be a first MLM (or one or more MLMs) to detect the network performance anomalous condition or subscriber need, and a second MLM to choose the network slice type and/or to generate the characteristics of the new network slice at step 225 and/or at step 230. In one example, step 230 may include transmitting instructions to one or more host devices to instantiate the dynamic on demand inter-operator carrier aggregation (e.g., to reserve resources for a new vSMF, vAMF, vUPF, etc. to be instantiated thereon, to cause interfaces and links between these NFs to be established, and so forth). In one example, step 230 may also include transmitting instructions to a NSSF, which may cause the NSSF to designate particular subscriber endpoint devices, classes of subscriber endpoint devices, or the like to be assigned to the new network slice supporting dynamic on demand inter-operator carrier aggregation. Alternatively, or in addition, the NSSF or the AMF of the first network slice may be configured to implement access class blocking or the like, e.g., to reduce traffic and/or to offload particular endpoint devices, classes or categories of endpoint device, etc. from the first network slice, and so forth. In an example in which the processing system may comprise a NWDAF or CAM, step 230 may include transmitting a request/instruction(s) to a SMO, a RIC, and/or a slice orchestrator to implement dynamic on demand inter-operator carrier aggregation on the new network slice, e.g., having characteristics that may be determined via one of the MLMs discussed above or according to one or more rules relating to instantiating dynamic on demand inter-operator carrier aggregation in response to a network performance anomaly/anomalous condition of a particular type, or a particular subscriber need, and so on.

At step 240, the processing system may detect that the network performance anomaly and/or subscriber need is no longer required, e.g., the processing system may perform a second data traffic inspection process. For instance, step 240 may comprise the same or similar operations as step 215 and/or step 220 as described above, but with respect to the network functions, host devices, etc. associated with the new network slice supporting dynamic on demand inter-operator carrier aggregation. In one example, step 240 may include adjusting a manner of network performance indicator data gathering and/or reporting. For instance, the processing system may increase a rate of data collection and/or data sampling with respect to one or more network performance indicators that may be most associated with the type of network performance anomalous condition that was detected.

At step 245, the processing system may de-instantiate the dynamic on demand inter-operator carrier aggregation service. For instance, to free up network resources, such as host devices/NFVI, the processing system may de-instantiate the dynamic on demand inter-operator carrier aggregation service. In one example, step 245 may include the processing system transmitting instructions to NFs, host devices/NFVI, etc. directly. In another example, such as where the processing system may comprise a NWDAF or a CAM, step 245 may include transmitting a request/instruction(s) to a SMO, a RIC, and/or a slice orchestrator, such as described above.

At optional step 250, the processing system may de-instantiate the new network slice. For example, if a new network slice was instantiated in optional step 235, then the processing system will de-instantiate the new network slice once the dynamic on demand inter-operator carrier aggregation service is no longer needed or supported.

Following step 245 and/or following the optional step 250, the method 200 proceeds to step 295 where the method 200 ends.

It should be noted that the method 200 may be expanded to include additional steps or may be modified to include additional operations with respect to the steps outlined above. For example, various steps of the method 200 may be repeated for the same or different portion of the cellular network, e.g., for network performance anomalies of the same or different types. In one example, the method 200 may be expanded to further include training one or more network performance anomaly detection/forecasting models. In this regard, in one example the method 200 may further include obtaining feedback, e.g., from network personnel, such as RAN engineers or the like. For instance, the feedback may indicate whether a decision to automatically implement the dynamic on demand inter-operator carrier aggregation service and/or to generate a new network slice was correct (or incorrect). Alternatively, or in addition, the feedback may indicate one or more network configuration setting/parameter values that is/are different from the one(s) automatically generated via optional step 235. In one example, this feedback may then be used to retrain the MLM(s) for determining whether to implement dynamic on demand inter-operator carrier aggregation and/or to instantiate a new network slice in response to network performance anomaly information, and/or a generative MLM that may output the recommended network slice configuration setting values. In one example, feedback may be used in conjunction with reinforcement learning, e.g., where configuration setting values determined at optional step 235 may be increased or decreased to observe whether corresponding improvements or degradations in performance may be exhibited in a network slice, and so forth. In one embodiment, carrier components as discussed above from non-cellular networks can be used in a carrier aggregation process without the use of a carrier component from a cellular network.

In one example, the method 200 may be expanded or modified to include steps, functions, and/or operations, or other features described above in connection with the example(s) of FIG. 1 and/or FIG. 3, or as described elsewhere herein. Thus, these and other modifications are all contemplated within the scope of the present disclosure.

In addition, although not specifically specified, one or more steps, functions, or operations of the example method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for instantiating a dynamic on demand inter-operator carrier aggregation service in a cellular network, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 306 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 305 for instantiating a dynamic on demand inter-operator carrier aggregation service (e.g., a software program comprising computer-executable instructions) can be loaded into memory 304 and executed by hardware processor element 302 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for instantiating a dynamic on demand inter-operator carrier aggregation service in a cellular network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
performing, by a processing system including at least one processor, a forecast of data traffic of a cellular network;
detecting, by the processing system, a need for an inter-operator carrier aggregation service in a future time period based on the forecast;
selecting, by the processing system, a first carrier component from at least one non-cellular network, wherein the at least one non-cellular network is distinct from the cellular network; and
instantiating, by the processing system, the inter-operator carrier aggregation service in the cellular network for an endpoint device, wherein the inter-operator carrier aggregation service implements a carrier aggregation process utilizing the first carrier component from the at least one non-cellular network and a second carrier component from the cellar network to provide data transmission to the endpoint device.

2. The method of claim 1, wherein the detecting is based on a data traffic inspection process and a network model, wherein the network model comprises a network state of the cellular network.

3. The method of claim 2, wherein the network state comprises a network topology, one or more network configuration setting values, and one or more performance indicator metrics.

4. The method of claim 2, wherein the detecting detects a network performance anomaly.

5. The method of claim 2, wherein the detecting detects a need of the endpoint device for the future time period.

6. The method of claim 1, further comprising:
instantiating, by the processing system, a network slice in the cellular network to support the inter-operator carrier aggregation service.

7. The method of claim 6, wherein the network slice comprises a plurality of cellular core network functions and at least one base station.

8. The method of claim 7, wherein the plurality of cellular core network functions comprises at least one access management function, at least one session management function, and at least one user plane function.

9. The method of claim 7, wherein the at least one base station comprises:
a gNodeB; or
an eNodeB.

10. The method of claim 7, wherein the at least one base station comprises:
a radio unit;
a distributed unit; and
a centralized unit.

11. The method of claim 2, wherein the data traffic inspection process comprises applying a set of packet information for one or more packets to a machine learning model that is configured to detect at least one of: a network performance anomaly or a need of the endpoint device.

12. The method of claim 11, wherein the need of the endpoint device comprises at least one of: a bandwidth need, a data processing speed need, a data transmission speed need, or a data transmission reliability need.

13. The method of claim 1, wherein the at least one non-cellular network comprises: a WiFi communication network, a fiber optic communication network, a non-terrestrial network, an acoustic communication networks, or a thermal communication network.

14. The method of claim 4, wherein the detecting the network performance anomaly comprises detecting that one or more network performance indicator values exceed one or more threshold values.

15. The method of claim 1, further comprising:
detecting, by the processing system, the inter-operator carrier aggregation service is no longer needed; and
de-instantiating, by the processing system, the inter-operator carrier aggregation service in the cellular network.

16. The method of claim 1, further comprising:
assessing, by the processing system, a service charge to an account of the endpoint device.

17. The method of claim 6, further comprising:
detecting, by the processing system, the inter-operator carrier aggregation service is no longer needed; and
de-instantiating, by the processing system, the network slice.

18. The method of claim 1, further comprising:
accounting, by the processing system, a delay associated with at least one of: the first carrier component or the second carrier component.

19. A non-transitory computer-readable medium storing instructions which, when executed by a processing system including at least one processor, cause the processing system to perform operations, the operations comprising:
performing a forecast of data traffic of a cellular network;
detecting a need for an inter-operator carrier aggregation service in a future time period based on the forecast;
selecting a first carrier component from at least one non-cellular network, wherein the at least one non-cellular network is distinct from the cellular network; and
instantiating the inter-operator carrier aggregation service in the cellular network for an endpoint device, wherein the inter-operator carrier aggregation service implements a carrier aggregation process utilizing the first carrier component from the at least one non-cellular network and a second carrier component from the cellar network to provide data transmission to the endpoint device.

20. An apparatus comprising:
a processing system including at least one processor; and
a computer-readable medium storing instructions which, when executed by the processing system, cause the processing system to perform operations, the operations comprising:
performing a forecast of data traffic of a cellular network;
detecting a need for an inter-operator carrier aggregation service in a future time period based on the forecast;
selecting a first carrier component from at least one non-cellular network, wherein the at least one non-cellular network is distinct from the cellular network; and
instantiating the inter-operator carrier aggregation service in the cellular network for an endpoint device, wherein the inter-operator carrier aggregation service implements a carrier aggregation process utilizing the first carrier component from the at least one non-cellular network and a second carrier component from the cellar network to provide data transmission to the endpoint device.
